(19) United States
(12) Patent Application Publication
(10) Pub. No.: US 2017/0312992 A1
(43) Pub. Date: Nov. 2, 2017

(54) METHOD AND APPARATUS FOR APPLYING A HEAT-ACTIVATED DOUBLE-SIDED ADHESIVE TAPE TO A SUPPORT

(71) Applicant: TECNOFIVE S.R.L., Strambino (IT)

(72) Inventor: Davide FURNO, Strambino (IT)

(73) Assignee: Tecnofive S.R.L., Strambino (IT)

(21) Appl. No.: 15/521,416

(22) PCT Filed: Oct. 28, 2015
(86) PCT No.: PCT/IB2015/058303

§ 371 Date: Apr. 24, 2017

(30) Foreign Application Priority Data
Oct. 28, 2014 (IT) MI2014A001847

(51) Int. Cl. B29C 65/48; B29C 65/00; B29C 63/02; B29C 65/16; B29C 65/10; B29C 65/50; B29L 31/30

(52) U.S. Cl. CPC B29C 65/4845; B29C 65/4835; B29C 66/83413; B29C 65/50; B29C 63/02; B29C 65/1632; B29C 65/10; B29L 2031/3005

(57) ABSTRACT

Method, and apparatus, for applying a heat-activated double-sided adhesive tape (10) to a support (20) by: activate by heating the double-sided adhesive tape (10) with laser light from at least two different laser light emitters (30), salid emitters each compörising an optical collimator (31) adapted to project a cylindrical light beam (33), and bringing into mutual contact said activated double-sided adhesive tape (10) with said support (20) in a contact zone so they join.

### FIELD OF THE INVENTION

The present invention relates to a method and apparatus for applying a heat-activated double-sided adhesive tape.

More in particular, the present invention relates to a method for optimizing the process of applying a heat-activated double-sided adhesive tape to a support, typically a support made of elastomeric material, thermoplastic material, PVC, silicones and so forth.

A further object of the present invention is an apparatus adapted to implement said method for applying double-sided adhesive tape to a support.

### DESCRIPTION OF THE PRIOR ART

It is known in various industrial sectors, e.g. in the automotive sector, to use double-sided adhesive tapes to obtain the adhesion by gluing of parts, e.g. seals made of elastomeric material, thermoplastic material, PVC, silicones and so forth, to surfaces of various kind.

The use of seals, in particular, is increasingly more common in various sectors. Such seals must guarantee the hermetic sealing during closure, e.g. of the door to which they are applied, when referring to the automotive sector. In the assembly processes of such seals to the surfaces, e.g. to the metal surface of a door referring again to the automotive field as non-limiting example of application, the seals reach the assembly chain already provided with a double-sided adhesive for fixing the seal to the surface.

Such double-sided adhesive tape is glued in advance to the seal by means of an application technique which includes the use of a heat source adapted, as known, to activate the double-sided adhesive tape.

The type of double-sided tape to which the method and apparatus according to the present invention relates is thus a tape comprising at least one layer of acrylic foam, or similar expanded material, said at least one layer of acrylic foam being covered by a heat-activated adhesive substance on one side and covered with a so-called liner, i.e. by a thin layer of polymeric material, e.g. polyethylene, adapted to be removed to allow the tape to be glued to a support, on the other side.

Thus, more in particular, the double-sided adhesive tape treated by the method and apparatus according to the present invention is used, in particular, for gluing seals to painted vehicle parts.

The double-sided adhesive tape thus comprises a layer of heat-activated adhesive on one side adapted to adhere by means of heat activation onto EPDM and TPE rubbers, while on the other side it comprises a self-adhesive layer protected by the liner, which once the liner is removed allows the tape itself to be quickly glued, and thus the seal, to the painted vehicle part.

Besides continuous applications, the market requires intermittent applications of double-sided adhesive tape to a support, i.e. applications in which the support parts provided with double-sided adhesive tape are alternated with support portions in which the double-sided adhesive is not positioned, this thus requiring automatic apparatuses for applying reactive double-sided adhesive tape provided with an instantaneous heat source, free from transient phenomena, the temperature of which must be always instantaneously controlled.

The known methods for applying a double-sided adhesive tape considered hereto require the use of an apparatus provided with opposite pulleys through which the double-sided adhesive tape and the support on which said double-sided adhesive tape must be applied are simultaneously passed.

The two pulleys must apply a regular, constant pressure between the two elements, double-sided adhesive tape and support, and for the coupling to occur correctly both elements must be aligned and guided in a linear, constant manner during the step of insertion into the pulleys.

The adhesion of the double-sided adhesive tape may be performed cold, with the use of primer and glue, or in the case of the heat-activated double-sided adhesive tapes considered hereto, by means of heat activation of the glues already present in the double-sided adhesive tape. Such glues are activated at a predetermined temperature, which is thus a fundamental parameter of the adhesion process.

In the adhesion process of a heat-activated adhesive of the type considered here to a support, it is thus fundamental to heat the union zone between the adhesive and the support to the activation temperature of the adhesive, and is fundamental for the correct outcome of the process that such a temperature is maintained constant, uniform throughout the adhesion zone and that there are no transients during the process, for example related to the reaching of the activation temperature during the step of starting up the process.

Not last, it is also very important that the heating of the heat-activated adhesive layer is performed on a level which is necessary and sufficient to obtain the activation of the adhesive itself but at the same time is such not to cause an excessive heating of the acrylic foam layer, which would cause as negative effect the heating and the consequent damaging of the adhesive placed on the opposite side of the acrylic foam with respect to the heat-activated double-sided adhesive tape.

Damaging the adhesive under the liner would compromise the possibility of effectively gluing the double-sided adhesive tape and the support, e.g. the seal, on which the double-sided adhesive tape is glued by means of the method and apparatus object of the present invention, and may also damage the liner itself which appears wrinkled and raised in multiple points from the acrylic foam layer as a consequence of the damage of the adhesive on liner side.

Currently, the methods and apparatuses of known type use heating elements, such as for example a hot air emitters (blowers) and heat resistors which take the heat-activated adhesive to activation temperature when correctly oriented.

As mentioned, the process also requires a heating of the support, e.g. consisting of the seal, which is hit by the hot air and is thus also considerably heated, in addition to the adhesive tape.

The heating of the support is another fundamental aspect for the good result of the adhesion process of the adhesive, and for this purpose it is known to provide infrared lights with strong heating power which increase the temperature of the support before the application of the double-sided adhesive tape.

The known methods for applying a double-sided adhesive tape have many drawbacks.

Firstly, the use of heating elements such as hot air emitters and heating resistors also causes a heating of parts of the apparatus surrounding in the union point between double-sided adhesive tape and support, thus compromising the quality of the end result because of the impossibility of concentrating the action of the source of heat in one point. Indeed, an uncontrolled increase of the temperature of the pulleys which transport the double-sided adhesive tape may, for example, cause damage to the liner, i.e. to the very thin part of the tape which is applied onto the surface of the double-sided adhesive tape to cover the zone not in contact with the support and which is removed when the support must be glued to the end product, for example to the door of a vehicle.

Another drawback which afflicts the methods of known type is the risk of early activation of the heat-activation process of the adhesive when the double-sided adhesive tape and the support are not yet in the correct reciprocal coupling position inside the pulleys.

A further drawback which afflicts the methods of known type consists in the risk that the high increase of temperature of the support could cause a deformation of the support by heat expansion. Since the support has a different thermal coefficient from that of the double-sided adhesive tape to which it must be coupled, the thermal deformation of the support may cause mechanical stresses once the double-sided adhesive tape has been applied and the elements have been cooled, which may bend the seal itself or wrinkle the liner, and thus ultimately the double-sided adhesive tape.

In order to reduce the effects of overheating, it is necessary with the methods and apparatuses of the known type, to cool all the parts concerned by the undesired heating by means of liquid, i.e. with jets of water, with considerable increase of costs and dimensions of the apparatus which performs the adhesion.

Again, the apparatuses of known type which use heating means as described require a relatively long time before the process of applying the double-sided adhesive tape stabilizes, because there is a transient step for the activation temperature of the double-sided adhesive tape to be reached, because the reaching of the desired temperature by the heating means is not instantaneous. This transient step inevitably creates waste material whenever the adhesion process is started and before it has warmed up.

Some known solutions of the prior art use laser apparatuses for applying tapes or covering layers of composite materials to a substrate.

An example of method and apparatus of known type is shown in U.S. Pat. No. 6,451,152 B1, in which a tape of composite material is applied to an article made of composite material by heating by means of an array of laser diodes which may be activated independently from one another so as to control the emitted power.

The patent teaches the use of an array comprising a plurality of laser diodes in order to allow a uniform energy distribution on a support and on a tape made of composite material in order to optimize the energy distribution as the application conditions of the tape vary, in particular to change the heating as a function of the curvatures of the support surface on which the tape must be applied.

Indeed, the patent states that if the heating of the tape is optimized for a given speed of the head which deposits the tape on the support when the surface of the latter is flat, the energy itself will be insufficient to heat the tape in the convex regions, while it will be excessive in the concave regions.

Prior document US '152 is thus not directed to the application of a heat-activated double-sided adhesive tape of the type considered here to a support of rubbery material, but is instead directed to the application of a composite material tape to a support also made of the same material.

Furthermore, the prior document does not teach to optimize the productivity of the tape deposition process in terms of application speed, but instead examines another technical problem, consisting in the need to vary the energy density which hits the tape.

Patents EP 1 334 819 A1 and US 2012/0285604 A1 are also known in the prior art. EP 1 334 819 A1 again relates to a method of layered application of composite materials and also in this case teaches to use a laser diode array. Also in this case, the control of the zones of the composite fibers to be treated occurs by means of a controller complex which determines the controlled switching on and off of the numerous diodes of the array. The prior patent requires each diode of the array to be connected to an independent power source so as to control the diodes independently from one another.

EP 819 solves the technical problem of optimizing the energy density distributed as a function, for example, of the dimensions of the fibers to be treated, which may be different, of the type of material of the fibers, which also in this case may be different, and so on.

For this reason, an array comprising a plurality of diodes and laser power sources allows the heating level to be optimized also according to the geometry of the substrate, which may have a non-flat surface and different curvature radii.

Ultimately, prior document US 2012/0285604 A1 describes a method and a device for covering artifacts made of wood, plastic or other similar materials, in which the use of at least two energy sources is described very generically. Such energy sources may consist of laser, infrared, ultrasound, magnetic field, microwave, plasma, gas emitters, and so on.

Thus, the patent does not teach to optimize the gluing production process of a heat-activated adhesive of the type considered here nor does it relate to the productivity of an apparatus of the type which is the object of the present invention.

### SUMMARY OF THE INVENTION

It is thus the main task of the present invention to provide a method and apparatus for applying a heat-activated double-sided adhesive tape of the above-described type, i.e. comprising a layer of heat-activated adhesive to a support which allows the drawbacks afflicting the methods and apparatus of known type to be solved.

Within this task, it is the object of the present invention to provide a method which allows the step of heating the heating means to be completely eliminated, thus considerably reducing or even completely eliminating waste, while completely eliminating the problems of deformation of the support caused by the heating thereof.

It is a further object of the present invention to provide a method for applying a heat-activated double-sided adhesive tape to a support which allows to have an instantaneous heating, which can be modulated and localized in the adhesion zone between double-sided adhesive tape and support.

Not last, it is the object of the present invention to provide a method in which only the portions of the support concerned by the application of the adhesive, and not the entire support, are heated.

It is also an object of the present invention to provide an apparatus for applying a heat-activated double-sided adhesive tape to a support which allows the method object of the present invention to be implemented and which is simpler to be manufactured, and thus more cost-effective.

In particular, it is the object of the present invention to provide an apparatus for applying a heat-activated double-sided adhesive tape to a support which does not require cooling means and which offers a high modularity and an accurate control of the caused heating.

It is yet another object of the invention to optimize the deposition process of a heat-activated double-sided adhesive tape of the type considered here, thus improving the productivity of the machine suited to implement said method, while obtaining an improvement of the final result in quality terms and an improvement of the productivity of the apparatus in terms of reduction of the process times necessary for the application of the support tape.

It is yet another object of the present invention to provide a method and apparatus adapted to implement said method, said apparatus being obtained in a simple manner by changing the apparatuses of known type which use hot air for heating the support, thus allowing the retrofitting of such apparatuses of known type in a simple, cost-effective manner.

This task and these and other objects are achieved by a method for applying a heat-activated double-sided adhesive tape and by an apparatus adapted to implement said method according to the appended independent claims.

Further features of the method and apparatus are mentioned in the dependent claims.

### BRIEF DESCRIPTION OF THE DRAWINGS

Further objects and advantages of the present invention will become apparent from the detailed description of a preferred embodiment of the present invention which is shown by way of non-limiting example in the accompanying drawings:

FIG. 1 diagrammatically shows a preferred embodiment of the apparatus for applying a heat-activated double-sided adhesive tape according to the present invention;

FIG. 2 shows a detail of FIG. 1;

FIG. 3 shows the Gaussian distribution of the energy emitted by the laser sources;

FIG. 4 diagrammatically shows the application of laser light to a heat-activated double-sided adhesive tape by means of the apparatus in FIGS. 1 and 2;

FIG. 5 shows the Gaussian distribution of the laser light generated by the apparatus according to the present invention;

FIG. 6 diagrammatically shows the reciprocal positioning of the laser light sources of the apparatus according to the present invention;

FIG. 7 shows an overview of a preferred embodiment of the apparatus applying a heat-activated double-sided adhesive tape according to the present invention.

### DESCRIPTION OF THE PREFERRED EMBODIMENT

According to a preferred embodiment described here by way of non-limiting example of the method for applying heat-activated double-sided adhesive tape according to the present invention, a laser light is used for causing the heating of the heat-activated adhesive substance present on the double-sided adhesive tape to obtain the adhesion of the double-sided adhesive tape to the surface of a support.

With reference to the accompanying figures, the method according to the present invention allows the heat-activated double-sided adhesive tape 10 to be fixed to a support 20 by using two laser light emitters 30, each comprising an optical collimator 31 capable of projecting a cylindrical light beam 33. The laser light emitters 30 may be each connected by means of an optical fiber 32 to a single laser light generator, not shown in the accompanying figures.

The method according to the present invention comprises the following steps:
preparing a support 20 on which said heat-activated double-sided tape 10 is adhered, and a heat-activated double-sided tape 10;
hitting at least one portion of said double-sided tape 10 with laser light from at least two different laser light emitters 30, in order to obtain at least one activated zone of double-sided tape 10;
bringing into mutual contact said at least one zone of activated double-sided tape 10 with said support 20 in a contact zone.

The method according to the present invention may further include also hitting at least one part of the support with said laser light from at least two emitters 30.

Said method further comprises the step of applying a pressure force between said support 20 and said double-sided adhesive tape 10 in the activated condition at said contact zone, as well as at least one step of calibrating the convergence and partial overlapping of the light beams 33 generated by the laser light emitters 30.

In order to allow the implementation of the method of the present invention, the apparatus also object of the present invention according to a preferred embodiment advantageously comprises a first wheel 40, which feeds the double-sided adhesive tape 10 preferably wound on a support coil, not shown in the drawings, and a second wheel 50 opposite to the first wheel. Said first 40 and second 50 wheels turn with mutually opposite sense of rotation, and their reciprocal position can be adjusted towards/away so that a space is defined for inserting support 20 at their tangent point, so that said support 20 inserted between the two wheels 40, 50 is moved forward by their rotation.

The two opposite and adjustable wheels allow the application of a pressure between said double-sided adhesive tape 10 and said support 20, thus optimizing the adhesion process.

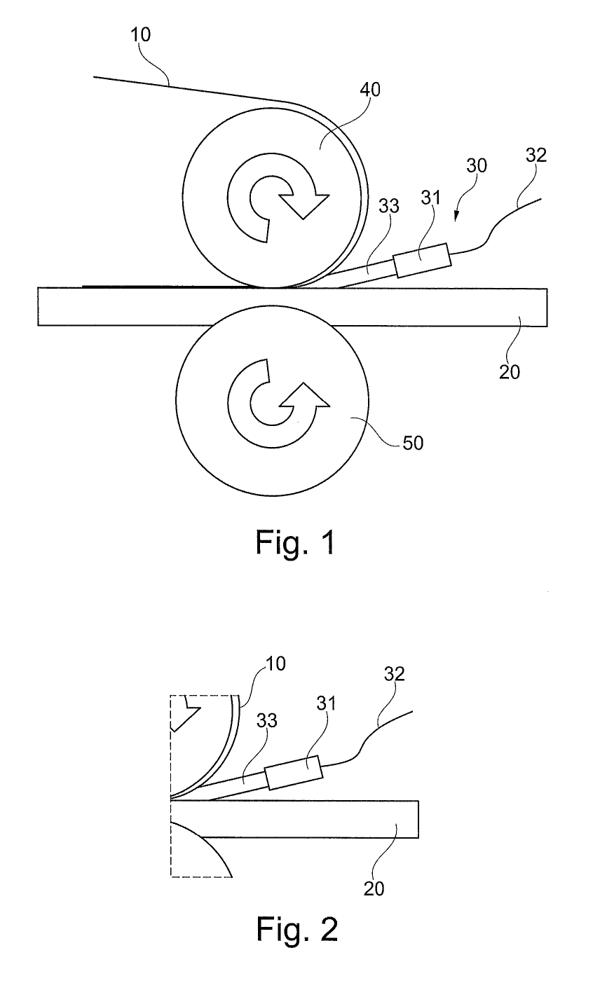

At the same time, the first wheel 40 feeds the double-sided adhesive tape 10 which is partially wound on it as shown in FIG. 1.

The double-sided adhesive tape 10 wound on the supporting coil is advantageously unwound by means of a mechanical system, not shown in the figures.

The double-sided adhesive tape 10 is thus guided by means of appropriate guiding means to the first wheel 40 which feeds the double-sided adhesive tape 10 to the contact zone with the support 50.

Advantageously, the double-sided adhesive tape 10 is guided by means of an adjustable slide, either manually or electrically by means of a servo motor, in order to be positioned correctly in the contact zone.

Said first wheel 40 may be made of metal or plastic material or other materials and may have a smooth or lined contact surface with the tape, according to needs, and may be provided with a shock absorber system which, by means of pneumatic or electric or spring means ensures that the double-sided adhesive tape 10 is pressed against support 20 again with the same previously set force.

In order to distribute the double-sided adhesive tape on the seal, either the support can be fed through a second motorized wheel 50 opposite to the first wheel 40 which supports the double-sided adhesive tape 10 or the support 20 can be kept still and the first wheel 40 can be moved thus making the axis of said first wheel 20 axially movable.

In the first case, corresponding to the preferred configuration shown in the accompanying figures, the second wheel 50 will be motorized independently from the first wheel 40 in order to avoid surface stresses which are dangerous for the result of the application.

The second wheel 50 may also be made of metal or plastic material and must be shaped each time according to the shape of the support section so as to operate also as guide for the support itself.

In the second case, corresponding to an alternative configuration of the apparatus, not shown on the accompanying drawings, support 20 will be appropriately contained within a static guide according to the section of the support 20 itself.

The apparatus according to the present invention further comprises at least two laser light emitters 30, each comprising an optical collimator 31 capable of projecting a cylindrical light beam 33 in direction of the contact zone between the double-sided adhesive tape 10 and the support 20. The laser light emitters 30 may be each connected by means of an optical fiber 32 to a single laser light generator or multiple laser light generators may be provided.

Said laser light emitters 30 being capable of generating a light having wavelength comprises between 780 and 1100 nanometers, preferably about 800 nanometers, even more preferably 808 nanometers.

This range of wavelengths is such that the light is absorbed by the plastic objects having a dark color, such as typically the double-sided adhesive tape 10 and the support 20, thus accumulating thermal energy.

The laser light generated by a laser diode is preferably transported by means of an optical fiber 32, e.g. preferably but not necessarily a 600 μm fiber, to the optical collimator 31, which is oriented towards the contact between the contact point with the double-sided adhesive tape 10 and the support 20, as shown in FIGS. 1, 2, 4 and 5.

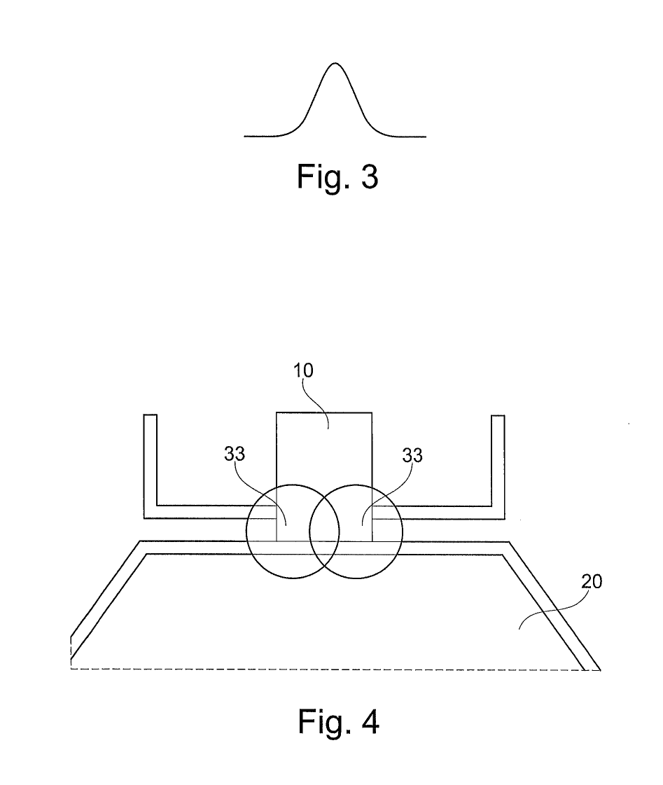

The particularity of the optical collimator used is that the light beam exiting therefrom assumes a cylindrical shape. The laser light concentrated in a cylindrical shape beam preferably of about 1 centimeter causes the heating of the hit surface by distributing the energy according to a Gaussian curve shown in FIG. 3, preferably with a super Gaussian distribution.

The apparatus according to the present invention includes using at least two non-confocal laser light sources 30, arranged side-by-side so as to project two cylindrical light beams which partially overlap, as shown in FIGS. 4, 5 and 6, at the contact zone of tape 10 with support 20.

Being the energy distribution of the Gaussian type, the energy in the center of the cylinder is higher than the outside.

The surface of the double-sided adhesive tape 10 to be activated may be up to about 20 mm wide, and so at least two cylindrical laser light beams side-by-side and partially overlapped must be used to maintain the energy constant and uniform on the entire double-sided adhesive tape surface to be activated.

By using for example two light source sources 30, each comprising an optical collimator for obtaining a laser source cylinder of diameter of about 1 cm each, and partially overlapping them, it will be possible to distribute a uniform amount of energy on the entire surface of the double-sided adhesive tape to be activated, thus obtaining a uniform result in terms of activation of the double-sided adhesive tape itself.

By manually adjusting the two collimators 31, or better still by positioning an electrical actuator so as to control the reciprocal position thereof accurately, the convergence of the cylindrical light beams 33 can be adjusted to optimize the distribution of energy, and thus of heat, in the contact zone between double-sided adhesive tape 10 and support 20, thus obtaining the desired activation of the glues on the double-sided adhesive tape and on the support, if it is consists of a rubber seal, to burn the surface oils of the rubber.

To provide some parameters, the two laser light sources could have a total power of about 400 watt. With such a power, a heat-activated tape of the type considered here having a width of about 8 mm may be hit over a length of about 15 mm with an energy density sufficient to obtain the complete, effective gluing to the rubber support and allowing a feed speed of the tape of 20 meters/minute.

According to a preferred embodiment of the present invention, the method and apparatus according to the present invention requires the two collimators 31 to be adjustable in space.

More preferably, besides being horizontally adjustable as described above to optimize the distribution of energy, and thus of heat, on the entire width of the tape as the width of the tape varies, such collimators 31 may be adjustable also vertically independently from each another, e.g. by requiring collimator 31 to be hinged to its support by means of a hinge.

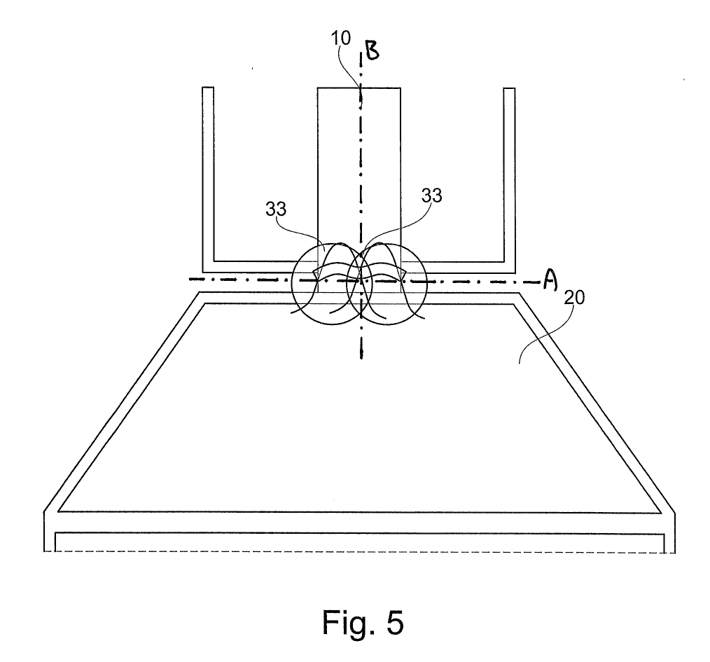

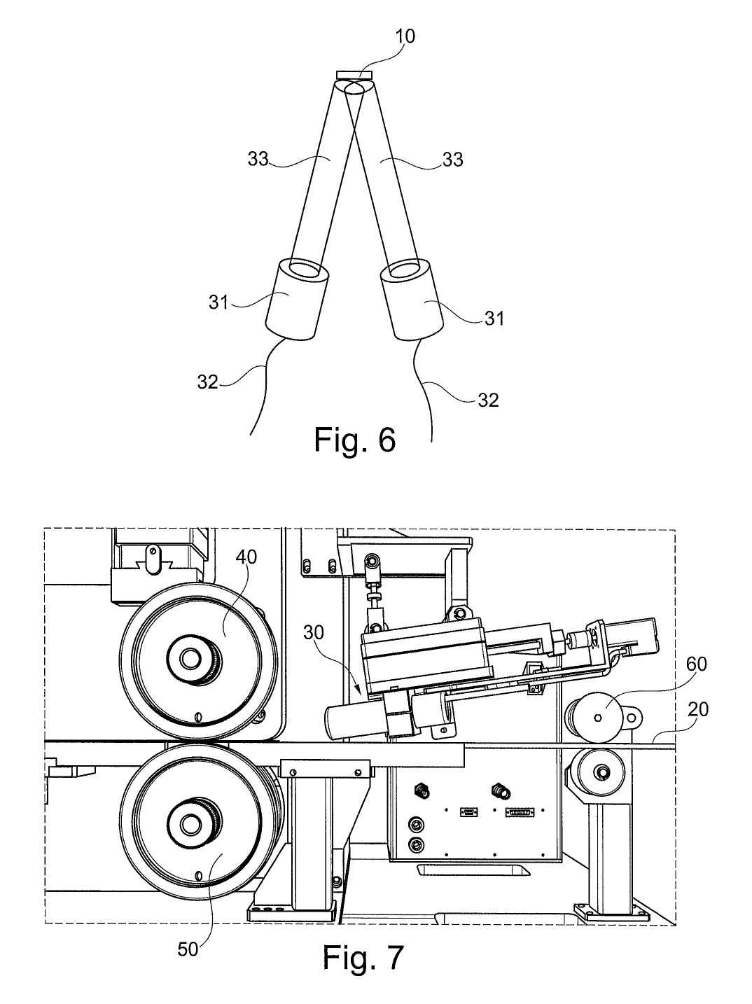

Therefore, with reference to the diagrammatic views in FIGS. 5 and 6, for example, not only the collimators 31 may be horizontally adjustable so that the light beams 33 at least partially converge on tape 10, while arranging themselves side-by-side along a transversal axis A with respect to tape 10, but can be arranged to overlap each other along the longitudinal axis of tape 10.

With reference to FIG. 1, for example, horizontal direction means the direction identified by the plane on which support 20 lies, and vertical direction means a direction vertical thereto. Similarly, with reference to FIG. 5, the transversal axis A lies on a horizontal plane.

As mentioned, the possibility of horizontal movement, along a transversal axis A, of the collimators 31, and thus of the light beams 33 produced thereby, allows the energy density to be optimized as a function of the tape width, thus making the apparatus suited to implement the method and versatile in order to heat supports 20 and tapes 10 having different widths.

When the width of the tape increases, the speed of the machine, and thus its productivity, decreases for because a power density suited for activating the heat-activated adhesive must be supplied.

When the width of the tape is considerable, the two light beams 33 produced by the collimators 31 must be arranged side-by-side possibly minimally overlapped, and thus there will be zones of the tape concerned by a lower energy density, being the distribution of energy of each light beam of the Gaussian type as mentioned.

Since the power is the product of the energy by unit of time, it results that if the energy density is lower, in order to obtain the power density needed to activate the heat-activated adhesive, it will be necessary to expose the tape to the light energy of the beams 33 for a longer period of time, and this is obtained by slowing down the feed speed of the tape.

Conversely, when the tape width is small, it is possible that one only light beam 33 produced by a single collimator 31 supplies the energy density sufficient for the activation of the adhesive to the tape, and thus in this case instead of activating a single collimator, with the suggested solution the second collimator 31 can be moved vertically so that the two light beams 33 are aligned vertically on the tape along the transversal axis B.

Thereby, a huge advantage can be obtained in terms of possible increase of the feed speed of the tape, with the speed of the machine even exceeding 20-25 meters a minute, to reach over 30 meters a minute.

The advantage achieved by aligning the two light beams 33 along the longitudinal axis B, thus along the longitudinal axis of tape 10, is indeed not only a consequence of a greater heated portion of tape, but also a consequence of the further reduction of the step of hysteresis which leads to the activation of the heat-activated adhesive: by overlapping the two light beams 33, the adhesive can be preheated with the light beam which hits the tape first with respect to the feed direction thereof, the beam which hits the tape first with respect to the feed direction thereof indicated by the arrow in FIG. 5, pre-heats the heat-activated adhesive, which is further heated by the second beam thus activating the adhesive nearly instantaneously.

This evidently allows a considerable increase of the process speed with a much higher machine productivity than any process and any machine of known type in the prior art.

According to a preferred embodiment of the present invention, said collimators 31 may be further provided with dedicated optics which allows the light beam 33 to be focused. Thereby, the beam itself can be converged or diverged by changing the amplitude of the zone of the tape hit by the light beam and the energy concentration. The presence of dedicated optics on the collimators 31 thus allows the energy density on the tape to be varied further.

Preferably, the method according to the present invention requires addressing the light source emitted by the sources 30 exclusively onto tape 10 and not onto the support. It has indeed been experimentally noted that in all cases support 20 indirectly receives an amount of energy sufficient for effectively completing the gluing process.

In order to control the adhesion process instant-by-instant and to monitor the correct activation of the adhesive and thus guarantee the achieved union between double-sided adhesive tape and support, the apparatus according to the present invention may advantageously comprise a temperature gauge, i.e. infrared, typically a pyrometer, by means of which the temperature reached by the double-sided adhesive tape and by the support at the contact point can be instantaneously monitored.

Thereby, visual and/or auditory alarm means can be associated if the temperature detected by the pyrometer during the process is out of the preset threshold values. Again by means of the temperature gauge, operatively connected to a control unit, the power of the laser light sources 30 can be automatically adjusted by means of the control unit so that the adhesion temperature is automatically adjusted within the correct threshold.

The central control unit processes the process parameters entered either manually by the operator, such as for example the nature of the materials of the double-sided adhesive tape and of the support, the width of the heat-activated adhesive tape and/or detected by the sensors present aboard the apparatus, such as, for example, the aforementioned temperature gauge, and a metric wheel (encoder) 60 which, by feeling the surface of support 20, checks the actual forward movement of the support itself, and compares them with preset threshold values stored in a storage module.

By means of comparison and adjustment module, said control unit compares the input process parameters with the reference parameter values stored in the memory module and then acts on the operating parameters of the apparatus, such as, for example, the position and power of the sources 30 and the feed speed of the support and of the double-sided adhesive tape.

Therefore, the central control unit may advantageously allow the position of the sources 30 to be changed automatically with respect to the contact zone between the heat-activated tape 10 and the support 20 during the process, by entering as input data the parameters related to the dimensions of the surface of the double-sided adhesive tape to be activated and of the support.

Advantageously, the apparatus comprises a control panel by means of which the process data is entered in the control unit, such as, for example, the sensitive dimensions of the double-sided adhesive tape and of the support, as well as the adhesive activation temperature, i.e. the process temperature, and the light absorption coefficients of the two materials, which may be pre-stored so that the operator can enter only the type of material of which the double-sided adhesive tape and the support are made, without needing to enter said coefficients each time.

Other parameters which can be advantageously changed by the operator are, for example, the position of the double-sided adhesive tape 10 with respect to support 20, the distance as mentioned of the collimators 31 with respect to the contact zone, i.e. with respect to the activation zone of the double-sided adhesive tape, the mechanical pressure exerted by said first 40 and second 50 wheel between double-sided adhesive tape and support, the power emitted by the laser sources 30, the rotation speed of the wheels and thus the feed speed of support and tape.

With regards to the possibility of varying the distance of the collimators 31 from the contact zone, it is worth noting that with respect to the known type solutions, and with respect to the solutions which require a plurality of diodes arranged in an array according to the prior patents mentioned above, the solution suggested here allows the laser sources 30 to be positioned further away from the heating zone of the tape, by using collimated beams, but also if slightly converging or diverging beams are used, thus avoiding fumes or the like from fouling the optics. This is reflected in a better quality of the end result of the process and lesser maintenance of the apparatus as compared to the systems of known type.

For this purpose, the apparatus will be provided, as mentioned, with a central control unit capable of processing the process data and comparing them with the pre-stored data and also with electric and/or pneumatic actuators capable of moving the wheels 40 and 50 and the collimators 31 of the laser sources 30.

As mentioned, the apparatus will advantageously comprise a metric wheel 60, commonly known as encoder, which by feeling the surface of support 20 checks the actual forward movement of the support itself, and subjects the activation of the laser sources 30 to the actual and correct forward movement of the support.

If the metric wheel 60 detects an incorrect movement of support 20, the laser will be instantaneously deactivated in order to avoid the risk of fire.

Many changes, modifications, variations and other uses and applications of the invention will be apparent to those skilled in the art after having considered the description and the accompanying drawings which illustrate preferred embodiments thereof. Such changes, modifications, variations and other uses and applications which do not differ from the scope of the invention as defined in the appended claims and form an integral part of the text are covered by the present invention.

1. A method for applying a heat-activated double-sided adhesive tape comprising the steps of:
preparing a heat-activated double-sided adhesive tape and a support on which said heat-activated double-sided adhesive tape is adhered;
hitting at least one portion of said double-sided adhesive tape with laser light from at least two different laser light emitters, said emitters each comprising an optical collimator adapted to project a cylindrical light beam, to obtain at least one activated zone of double-sided adhesive tape, wherein said optical collimators are arranged so that said cylindrical light beams, projected on said at least one portion of heat-activated double-sided adhesive tape, are partially overlapping at the portion of double-sided adhesive tape to be activated; and
bringing into mutual contact said at least one zone of activated double-sided adhesive tape with said support in a contact zone.

2. The method according to claim 1, wherein said optical collimators are horizontally movable so as to orient said light beam at least along a transversal axis (B) with respect to said tape.

3. The method according to claim 1, wherein said optical collimators are vertically movable so as to orient said light beam at least along a longitudinal axis (B) with respect to said tape.

4. The method according to claim 1, wherein said laser light from said at least two laser light emitters further hits at least one portion of said support.

5. The method according to claim 1 further comprising the step of applying a pressure between said support and said double-sided adhesive tape.

6. The method according to claim 1 further comprising a step of calibrating the convergence and partial overlapping of said cylindrical laser light beams projected by said emitters.

7. An apparatus for applying heat-activated double-sided adhesive tape to a support according to a method as claimed in claim 1, said apparatus comprising at least two laser light emitters, wherein each of said emitters comprises an optical collimator adapted to project a cylindrical laser light beam on at least one portion of said double-sided adhesive tape, and in that said at least two collimators are arranged so that said at least two laser beams are at least partially overlapping at the zone of the double-sided adhesive tape to be activated.

8. The apparatus according to claim 7, wherein said optical collimators are horizontally movable so as to orient said light beam at least along a transversal axis (B) with respect to said tape.

9. The apparatus according claim 7, wherein said optical collimators are vertically movable so as to orient said light beam at least along a longitudinal axis (B) with respect to said tape.

10. The apparatus according to claim 9 further comprising a temperature gauge adapted to monitor instantaneously the temperature reached by the portion of double-sided adhesive tape hit by the laser light.

11. The apparatus according to claim 10 further comprising at least one central control unit comprising, in turn, at least one data acquisition module configured to receive the input process parameter values, at least one memory module configured to store reference values of the process parameters, and at least one comparison and adjustment module configured to compare the input process parameters with the values of the reference parameters stored in the memory module and to change the operation parameters of the apparatus accordingly.

12. The apparatus according to claim 11 further comprising at least one control panel for entering the input process parameters by the operator.

13. The method according to claim 2, wherein said laser light from said at least two laser light emitters further hits at least one portion of said support.

14. The method according to claim 3, wherein said laser light from said at least two laser light emitters further hits at least one portion of said support.

15. The method according to claim 5 further comprising a step of calibrating the convergence and partial overlapping of said cylindrical laser light beams projected by said emitters.

16. The apparatus according claim 8, wherein said optical collimators are vertically movable so as to orient said light beam at least along a longitudinal axis (B) with respect to said tape.
